(19) United States
(12) Patent Application Publication
(10) Pub. No.: US 2006/0173921 A1
(43) Pub. Date: Aug. 3, 2006

(54) System and method for data transmission and reception

(76) Inventor: Esa Jalonen, Espoo (FI)

Correspondence Address: MORGAN & FINNEGAN, L.L.P., 3 WORLD FINANCIAL CENTER, NEW YORK, NY, 10281-2101, US

(21) Appl. No.: 10/536,044

(22) PCT Filed: Nov. 17, 2003
(86) PCT No.: PCT/IB03/05283

§ 371 Date: Oct. 3, 2005

Related U.S. Application Data
(60) Provisional application No. 60/427,797, filed on Nov. 20, 2002.

(51) Int. Cl. G06F 17/30

(52) U.S. Cl. 707/200

(57) ABSTRACT

Systems and methods for file transmission and reception that involve augmenting protocols such as real time protocol (RTP), a protocol for transmitting and receiving real-time data such as audio, video and simulation data, so that they may be used for file transmission and reception. Further systems and methods for file transmission and reception allow for one or more files to be transmitted for presentation in synchrony with media such as audio, video, or the like.

### FIELD OF INVENTION

This invention relates to systems and methods for data distribution.

### BACKGROUND INFORMATION

In recent years, there has been an increase in the use of wired and wireless networks for the transmission and reception of files. Such files can include, for example, MP3 files, text files, portable document format (PDF) files, and multimedia messaging service (MMS) files.

In light of this, there may be interest in technologies that facilitate the transmission of such files.

### SUMMARY OF THE INVENTION

According to embodiments of the present invention, there are provided systems and methods for file transmission and reception. Various of these embodiments involve augmenting protocols such as real time protocol (RTP), a protocol for transmitting and receiving real-time data such as audio, video and simulation data, so that they may be used for file transmission and reception.

Further embodiments of the present invention provide systems and methods for file transmission and reception wherein one or more files are transmitted for presentation in synchrony with media such as audio, video, or the like.

### BRIEF DESCRIPTION OF THE DRAWINGS

FIG. 1 shows an exemplary packet structure according to various embodiments of the present invention.

FIG. 2 shows various aspects of synchronized transmission and reception according to various embodiments of the present invention.

FIG. 3 shows an exemplary system employable in various embodiments of the present invention.

FIG. 4 shows various exemplary steps from a user point of view according to various embodiments of the present invention.

FIG. 5 shows various exemplary steps regarding how a user can select where files will be stored in a terminal according to various embodiments of the present invention

FIG. 6 shows an exemplary general purpose computer employable in various embodiments of the present invention.

FIG. 7 shows a functional block diagram of an exemplary terminal employable in various embodiments of the present invention.

### DETAILED DESCRIPTION OF THE INVENTION

General Operation

According to embodiments of the present invention, there are provided systems and methods for file transmission and reception. Various of these embodiments involve augmenting real time protocol (RTP), a protocol for transmitting and receiving real-time data such as audio, video and stimulation data, so that it may be used for file transmission and reception. Such augmentation can involve the inclusion of a custom metadata header. It is noted that, for various embodiments, one or more protocols similar to RTP may be employed along with or in place or RTP.

Further embodiments of the present invention provide systems and methods for file transmission and reception wherein one or more files are transmitted for presentation in synchrony with media such as audio, video, or the like. For such embodiments, file transmission may involve augmenting RTP or a similar protocol as discussed above.

It is noted that embodiments of the present invention are applicable to unicast, multicast, and broadcast. It is further noted that embodiments of the present invention are applicable to unidirectional and bi-directional networks.

Various aspects of the present invention will now be discussed in greater detail.

File Transmission

A first step in transmitting a file for various embodiments of the present invention may be to divide the file into a number of blocks. For each block, certain informational elements may be recorded in, for instance, an accessible storage location. The informational for a particular block may, for instance, relate to the particular element and/or the corresponding file.

Next, for each file block, an application layer packet (e.g., an RTP packet) carrying that block may be created and dispatched. Dispatch of each application layer packet may involve the use of one or more appropriate lower layer protocols. For instance, each application layer packet may be encapsulated in, for instance, a User Datagram Protocol (UDP) packet, which could in turn be encapsulated in, for instance, an Internet Protocol (IP) packet. Appropriate stops could be taken to so that each application layer packet would be dispatched to one or more intended recipients. Accordingly, for example, an IP packet of the sort just alluded to could contain in one of its headers the IP address on an intended recipient.

Each application layer packet could be created in a manner consistent with RTP or a similar protocol augmented in the manner alluded to above. More specifically, a step in the creation of each such packet may be the creation of a custom metadata header. Included in the custom metadata header may be information corresponding the file and/or file block with which the application layer packet is associated. Among this data may be one or more of a number of elements. Such elements might, for example, be in the form:
<meta-data field>:<value>;

In this exemplary form, “:” is used as a separator character between the meta-data field title and the value, while the “;” is used to separate each meta-data item from the others.

One element may, for example, be an indication of the filestructure location (e.g., directory or folder) where the file being transmitted should be stored at a recipient node. Such an element might, for instance, be:
Content-Base:/tmp/;

Another element may be, for example, the file name that a recipient node should use in storing the file being transmitted. Such an element might, for instance, be:
Content-Location:filename.ps;

Yet another element may be, for example, the size of the file being transmitted. The size might be specified in bytes. Such an element might, for instance, be:
Content-Length:200000;

Another element may be, for example, the sequence number for the corresponding file block. Also specified may be the total number of file blocks being dispatched. For instance, the element “12/20” might indicate that the corresponding application layer packet holds the 12th out of twenty blocks corresponding to the file being transmitted. Such an element might, for instance, be:
Content-Fragment:12/20;

A next element might be, for example, a content-offset indication. This element could indicate the starting position of the corresponding file block in the file being transferred. Such an element might, for instance, be:
Content-Offset:120000;

Another element could be, for instance, an indication of block size.

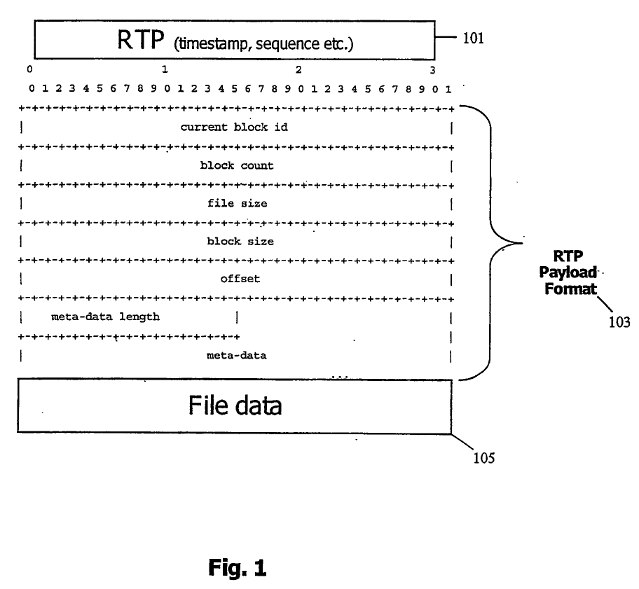

After creation of the custom metadata header corresponding to the transmission of a particular file block, the size of the metadata header could be calculated. Next, the custom metadata header could be placed in the payload portion of the RTP or similar application layer packet being created. Placed before or after the payload portion could be the calculated size of the header. Next an appropriate standard header (e.g., standard RTP header) could be created and appended to the packet. Where, the header is an RTP header, marker bit might be set to zero, extension bit might be set to zero, padding bit may be set to zero, and/or a dynamic payload type may be specified for payload type. More specifically, a value of 101 may be specified for payload type. Shown in FIG. 1 is an exemplary packet structure including RTP header 101, RTP payload format 103, and file data 105.

File Reception

Among the steps performed by a node receiving an application layer packet created and dispatched as discussed above may be to analyze the above-discussed custom metadata header. As alluded to above, data elements included in the header could, for instance, provide the recipient node with various information concerning the file being transmitted. For example, the recipient node could learn from the directory and/or file name to be associated with the file being transmitted. As another example, content-offset information included in the header could be used in reconstruction of the file being transmitted.

As another example, the recipient node could employ sequence number information included in the header to determine file blocks not received. For various embodiments of the present invention, there might be periodic retransmission of file blocks. For such embodiments, a recipient node could watch for the retransmission of file blocks that were not received.

As yet another example, the recipient node could employ file size information included in the header to determine progress in file reception. A recipient node could, for example, use such file size information in displaying a file receipt progress bar to a node user.

Synchronized File Transmission and Reception

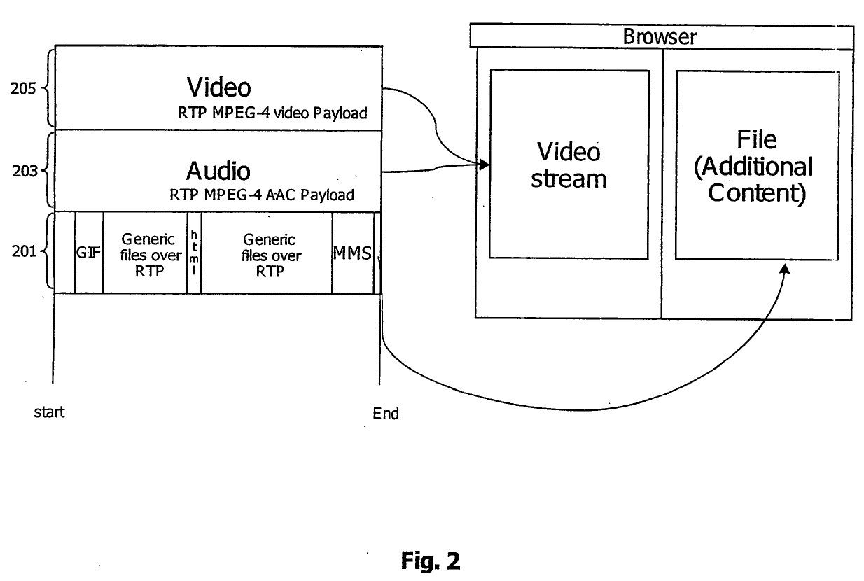

With regard to FIG. 2 it is noted that, as alluded to above, in various embodiments of the present invention, transmission of the sort described above may be employed in a manner such that one or more files (201) are transmitted for presentation in synchrony with media such as audio (203), video (205), or the like.

In such embodiments, a file could be transmitted in a manner similar to that described above, but with timing data being dispatched along with file blocks. The timing data could, for instance, be included in standard RTP headers or the like, and/or as elements in custom metadata headers. Timing data could further be dispatched along with packets of transmitted audio, video, and/or the like.

The timing data dispatched along with packets of transmitted audio, video, and/or the like and the timing data dispatched along with the file blocks could be correlated so as to allow for synchrony in presentation of the audio, video, and/or the like and one or more files corresponding to the dispatched file blocks.

As a specific example, in the case where transmitted audio, video, and/or the like corresponded to a streaming media film of a hockey match, timing data could, for instance, provide for the presentation of the image file of a player upon the streaming media film showing that player scoring a goal. For various embodiments, a store correlating media items and files could be maintained. As a specific example, such a store might, for instance, indicate image files to be shown in synchrony with the exemplary hockey match streaming media.

Accordingly, a node receiving such audio, video, and/or the like, and application layer packets containing file blocks corresponding to one or more files, could examine included timing data in order to provide a synchronized presentation of the sort noted above.

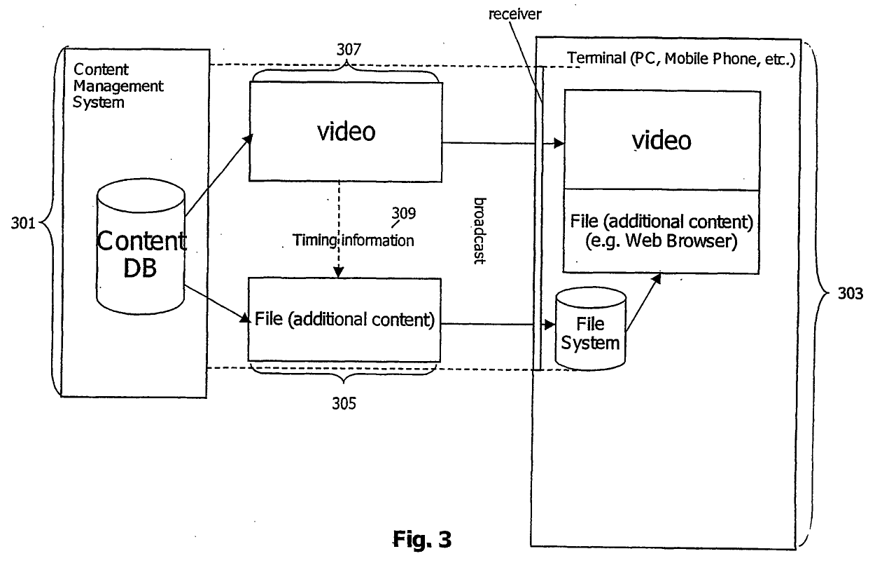

Shown in FIG. 3 is an exemplary system employable in various embodiments of the present invention including content management system 301 and terminal 303. Depicted in FIG. 3 is additional content 305 being transmitted for presentation in synchrony with video 307 in accordance with timing information 309.

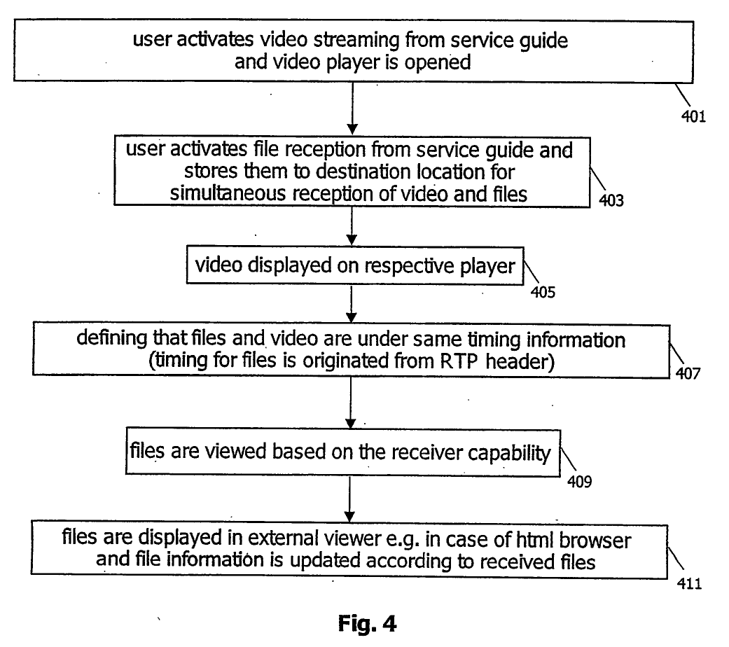

Shown in FIG. 4 are various exemplary steps from a user point of view according to various embodiments of the present invention. In step 401, a user activates video streaming from a service guide, and a video player is opened. In step 403, the user activates file reception from the service guide and files are stored to a destination location for simultaneous reception of video and files. In step 405, video is displayed. In step 407, defining that files and video are under the same timing information is performed. In step 409, files are viewed based on receiver capability. In step 411, files are displayed in one or more external viewers.

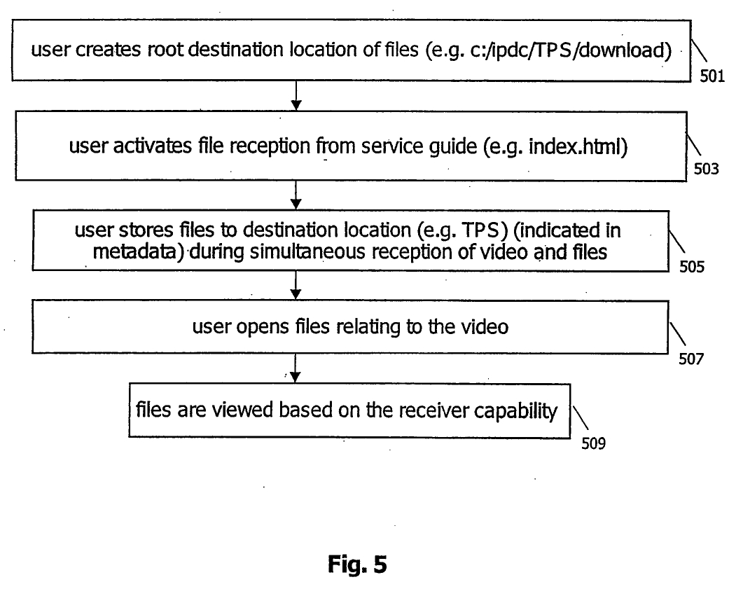

Shown in FIG. 5 are various exemplary steps regarding how a user can select where files will be stored in a terminal according to various embodiments of the present invention. In step 501, a user creates a root destination location. In step 503 the user activates file reception from a service guide. In step 505, files are stored to the destination location during simultaneous reception of video and files. In step 507, files relating to the video are opened. In step 509, the files are viewed based on receiver capability.

Hardware and Software

Certain devices employed in accordance with the present invention may be implemented using computers. For example, the above-noted nodes may be implemented using network-capable computers. For instance, a receiving node could be a wireless terminal. Furthermore, certain procedures and the like described herein may be executed by or with the help of computers. The phrases “computer”, “general purpose computer”, and the like, as used herein, refer but are not limited to a processor card smart card, a media device, a personal computer, an engineering workstation, a PC, a Macintosh, a PDA, a wired or wireless terminal, a server, a network access point, a network multicast point, or the like, perhaps running an operating system such as OS X, Linux, Darwin, Windows CE, Windows XP, Palm OS, Symbian OS, or the like, perhaps with support for Java or .Net.

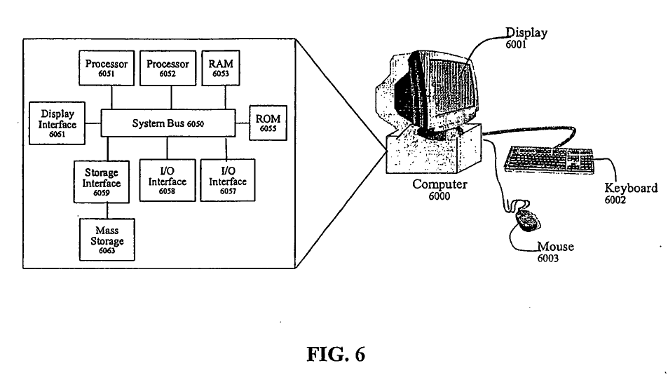

The phrases “general purpose computer”, “computer”, and the like also refer, but are not limited to, one or more processors operatively connected to one or more memory or storage units, wherein the memory or storage may contain data, algorithms, and/or program code, and the processor or processors may execute the program code and/or manipulate the program code, data, and/or algorithms. Accordingly, exemplary computer 6000 as shown in FIG. 6 includes system bus 6050 which operatively connects two processors 6051 and 6052, random access memory (RAM) 6053, read-only memory (ROM) 6055, input output (I/O) interfaces 6057 and 6058, storage interface 6059, and display interface 6061. Storage interface 6059 in turn connects to mass storage 6063. Each of I/O interfaces 6057 and 6058 may be an Ethernet, IEEE 1394, IEEE 802.11b, Bluetooth, terrestrial digital video broadcast (DVB-T), satellite digital video broadcast (DVB-S), digital audio broadcast (DAB), general packet radio service (GPRS), universal mobile telecommunications service (UMTS), or other interface known in the art.

Mass storage 6063 may be a hard drive, optical drive, or the like. Processors 6051 and 6052 may each be a commonly known processor such as an IBM or Motorola PowerPC, an AMD Athlon, an AMD Opteron, an Intel ARM, an Intel XScale, a Transmeta Crusoe, or an Intel Pentium. Computer 6000 as shown in this example also includes an display unit 6001, a keyboard 6002 and a mouse 6003. In alternate embodiments, keyboard 6002, and/or mouse 6003 might be replaced and/or augmented with a touch screen, pen, and/or keypad interface. Computer 6000 may additionally include or be attached to card readers, DVD drives, or floppy disk drives whereby media containing program code may be inserted for the purpose of loading the code onto the computer.

In accordance with the present invention, a computer may run one or more software modules and/or additional software designed to perform on or more of the above-described operations, the modules and/or additional software being programmed using languages such as Java, Objective C, C, C#, and/or C++ according to methods known in the art. It is noted that any described division of operations among particular software modules and/or additional software is for purposes of illustration, and that alternate divisions of operation may be employed. Accordingly, operations discussed as being performed by one software module and/or additional software item might instead be performed by a plurality of software modules and/or additional software. Similarly, operations discussed as being performed by a plurality of modules and/or additional software might instead be performed by a single module and/or additional software item.

Further, although embodiments of the invention disclose certain software modules and/or additional software as operating on certain devices, in alternate embodiments these modules might be distributed to run on other devices than those stated. For example, operations disclosed as being performed by a particular node might instead be performed by a plurality of nodes and/or other devices. It is further noted that, in various embodiments, grid computing techniques may be employed.

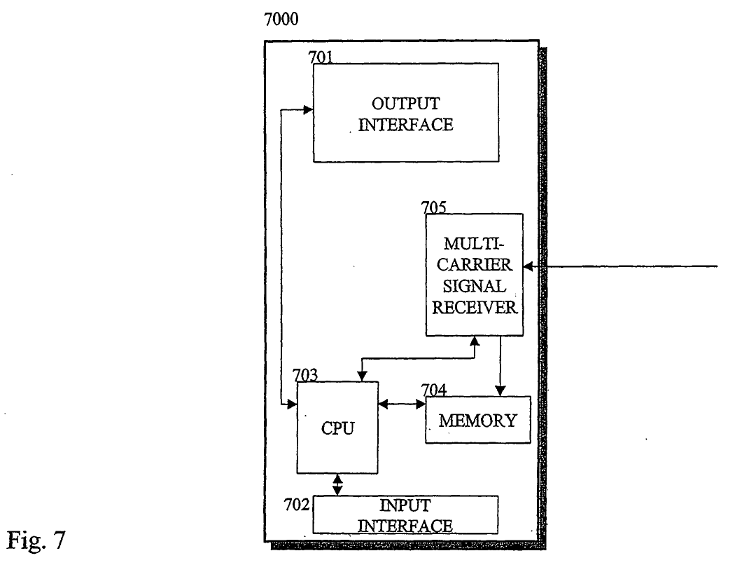

Shown in FIG. 7 is a functional block diagram of an exemplary terminal employable in various embodiments of the present invention. The terminal of FIG. 7 has been discussed in the foregoing. In the following, corresponding reference signs have been applied to corresponding parts. Terminal 7000 of FIG. 7 may be used in any/all of the embodiments described herein. The terminal 7000 comprises a processing unit CPU 703, a multi-carrier signal terminal part 705 and a user interface (701, 702). The multi-carrier signal terminal part 705 and the user interface (701, 702) are coupled with the processing unit CPU 203. One or more direct memory access (DMA) channels may exist between multi-carrier signal terminal part 705 and memory 704. The user interface (701, 702) comprises a display and a keyboard to enable a user to use the terminal 7000. In addition, the user interface (701, 702) comprises a microphone and a speaker for receiving and producing audio signals. The user interface (701, 702) may also comprise voice recognition (not shown).

The processing unit CPU 703 comprises a microprocessor (not shown), memory 704 and possibly software. The software can be stored in the memory 704. The microprocessor controls, on the basis of the software, the operation of the terminal 7000, such as the receiving of the data stream, the tolerance of the impulse burst noise in the data reception, displaying output in the user interface and the reading of inputs received from the user interface. The operations are described above. The hardware contains circuitry for detecting the signal, circuitry for demodulation, circuitry for detecting the impulse, circuitry for blanking those samples of the symbol where significant amount of impulse noise is present, circuitry for calculating estimates, and circuitry for performing the corrections of the corrupted data.

Still referring to FIG. 7, alternatively, middleware or software implementation can be applied. The terminal 7000 can be a hand-held device which the user can comfortably carry. Advantageously, the terminal 7000 can be a cellular mobile phone which comprises the multi-carrier signal terminal part 705 for receiving the multicast transmission stream. Therefore, the terminal 7000 may possibly interact with the service providers.

Ramifications and Scope

Although the description above contains many specifics, these are merely provided to illustrate the invention and should not be construed as limitations of the invention's scope. Thus it will be apparent to those skilled in the art that various modifications and variations can be made in the system and processes of the present invention without departing from the spirit or scope of the invention.

What is claimed is:

1. A method for transmitting a file, comprising:
dividing said file into a plurality of blocks;
transmitting to a recipient node a plurality of real time protocol packets, each packet containing at least one of said blocks;
wherein each of said packets contains a custom metadata header, the custom metadata headers allowing for reconstruction of said file at said recipient node.

2. The method of claim 1, wherein said each of said custom metadata headers contains a file structure location indication.

3. The method of claim 1, wherein said each of said custom metadata headers contains a file name.

4. The method of claim 1, wherein said each of said custom metadata headers contains a file size.

5. The method of claim 1, wherein said each of said custom metadata headers contains a sequence number.

6. The method of claim 1, wherein said each of said custom metadata headers contains a content-offset indication.

7. The method of claim 1, wherein said each of said custom metadata headers contains a block size indication.

8. A method for transmission of a file, comprising:
dividing said file into a plurality of blocks;
transmitting to a recipient node a media presentation, wherein first timing data is transmitted with said media presentation;
transmitting to said recipient node a plurality of real time protocol packets, each packet containing at least one of said blocks, each packet further containing second timing data;
wherein each of said packets contains a custom metadata header, the custom metadata headers allowing for reconstruction of said file at said recipient node; and
wherein said first timing data and said second timing data are employed in synchronized presentation of said file and said media presentation at said recipient node.

9. The method of claim 8, wherein said each of said custom metadata headers contains a file structure location indication.

10. The method of claim 8, wherein said each of said custom metadata headers contains a file name.

11. The method of claim 8, wherein said each of said custom metadata headers contains a file size.

12. The method of claim 8, wherein said each of said custom metadata headers contains a sequence number.

13. The method of claim 8, wherein said each of said custom metadata headers contains a content-offset indication.

14. The method of claim 8, wherein said each of said custom metadata headers contains a block size indication.

15. A method for file transmission, comprising:
receiving from a recipient node a request for a media presentation;
consulting a store correlating media presentations and files to determine a file associated with said media presentation.
dividing said file into a plurality of blocks;
transmitting to said recipient node said media presentation, wherein first timing data is transmitted with said media presentation;
transmitting to said recipient node a plurality of real time protocol packets, each packet containing at least one of said blocks, each packet further containing second timing data;
wherein each of said packets contains a custom metadata header, the custom metadata headers allowing for reconstruction of said file at said recipient node; and
wherein said first timing data and said second timing data are employed in synchronized presentation of said file and said media presentation at said recipient node.

16. The method of claim 15, wherein said each of said custom metadata headers contains a file structure location indication.

17. The method of claim 15, wherein said each of said custom metadata headers contains a file name.

18. The method of claim 15, wherein said each of said custom metadata headers contains a file size.

19. The method of claim 15, wherein said each of said custom metadata headers contains a sequence number.

20. The method of claim 15, wherein said each of said custom metadata headers contains a content-offset indication.

21. The method of claim 15, wherein said each of said custom metadata headers contains a block size indication.

22. A system for transmitting a file, comprising:
a memory having program code stored therein; and
a processor operatively connected to said memory for carrying out instructions in accordance with said stored program code;
wherein said program code, when executed by said processor, causes said processor to perform the steps of:
dividing said file into a plurality of blocks;
transmitting to a recipient node a plurality of real time protocol packets, each packet containing at least one of said blocks;
wherein each of said packets contains a custom metadata header, the custom metadata headers allowing for reconstruction of said file at said recipient node.

23. The system of claim 22, wherein said each of said custom metadata headers contains a file structure location indication.

24. The system of claim 22, wherein said each of said custom metadata headers contains a file name.

25. The system of claim 22, wherein said each of said custom metadata headers contains a file size.

26. The system of claim 22, wherein said each of said custom metadata headers contains a sequence number.

27. The system of claim 22, wherein said each of said custom metadata headers contains a content-offset indication.

28. The system of claim 22, wherein said each of said custom metadata headers contains a block size indication.

29. A system for transmission of a file, comprising:
a memory having program code stored therein; and
a processor operatively connected to said memory for carrying out instructions in accordance with said stored program code;
wherein said program code, when executed by said processor, causes said processor to perform the steps of:
dividing said file into a plurality of blocks;
transmitting to a recipient node a media presentation, wherein first timing data is transmitted with said media presentation;
transmitting to said recipient node a plurality of real time protocol packets, each packet containing at least one of said blocks, each packet further containing second timing data;
wherein each of said packets contains a custom metadata header, the custom metadata headers allowing for reconstruction of said file at said recipient node; and
wherein said first timing data and said second timing data are employed in synchronized presentation of said file and said media presentation at said recipient node.

30. The system of claim 29, wherein said each of said custom metadata headers contains a file structure location indication.

31. The system of claim 29, wherein said each of said custom metadata headers contains a file name.

32. The system of claim 29, wherein said each of said custom metadata headers contains a file size.

33. The system of claim 29, wherein said each of said custom metadata headers contains a sequence number.

34. The system of claim 29, wherein said each of said custom metadata headers contains a content-offset indication.

35. The system of claim 29, wherein said each of said custom metadata headers contains a block size indication.

36. A system for file transmission, comprising:
a memory having program code stored therein; and
a processor operatively connected to said memory for carrying out instructions in accordance with said stored program code;
wherein said program code, when executed by said processor, causes said processor to perform the steps of:
receiving from a recipient node a request for a media presentation;
consulting a store correlating media presentations and files to determine a file associated with said media presentation.
dividing said file into a plurality of blocks;
transmitting to said recipient node said media presentation, wherein first timing data is transmitted with said media presentation;
transmitting to said recipient node a plurality of real time protocol packets, each packet containing at least one of said blocks, each packet further containing second timing data;
wherein each of said packets contains a custom metadata header, the custom metadata headers allowing for reconstruction of said file at said recipient node; and
wherein said first timing data and said second timing data are employed in synchronized presentation of said file and said media presentation at said recipient node.

37. The system of claim 36, wherein said each of said custom metadata headers contains a file structure location indication.

38. The system of claim 36, wherein said each of said custom metadata headers contains a file name.

39. The system of claim 36, wherein said each of said custom metadata headers contains a file size.

40. The system of claim 36, wherein said each of said custom metadata headers contains a sequence number.

41. The system of claim 36, wherein said each of said custom metadata headers contains a content-offset indication.

42. The system of claim 36, wherein said each of said custom metadata headers contains a block size indication.
